(19) United States
(12) Patent Application Publication
(10) Pub. No.: US 2026/0166791 A1
(43) Pub. Date: Jun. 18, 2026

(54) MOLDING MANAGEMENT SYSTEM

(71) Applicant: SEIKO EPSON CORPORATION, Tokyo (JP)

(72) Inventor: Tomohiro TAKIZAWA, MATSUMOTO-SHI (JP)

(21) Appl. No.: 19/422,792

(22) Filed: Dec. 17, 2025

(30) Foreign Application Priority Data
Dec. 18, 2024 (JP) 2024-221429

(51) Int. Cl. B29C 45/76

(52) U.S. Cl. CPC B29C 45/76; B29C 2045/7606; B29C 2945/76076

(57) ABSTRACT

A molding management system includes an information processing apparatus and manages production of a product by an injection molding apparatus. The information processing apparatus acquires cycle data including first quantity information indicating a value of a first quantity controlled by the injection molding apparatus for each cycle, acquires injection molding condition data including first target value information indicating a first target value in control of the first quantity by the injection molding apparatus as one piece of injection molding condition information indicating an injection molding condition set in the cycle each time the injection molding condition is set, and causes a display unit to display abnormality occurrence period information indicating at least a part of an abnormality occurrence period in which an abnormality occurs in the first cycle based on acquired first cycle data and acquired first injection molding condition data in response to a received first operation.

The present application is based on, and claims priority from JP Application Serial Number 2024-221429, filed Dec. 18, 2024, the disclosure of which is hereby incorporated by reference herein in its entirety.

### BACKGROUND

### 1. Technical Field

The present disclosure relates to a molding management system.

### 2. Related Art

A technique for managing production of a product in a production process including an injection molding process of the product by an injection molding apparatus has been studied and developed.

Here, a technique is known in which reference waveform data indicating a plurality of reference waveforms serving as waveforms indicating a change over time in a quantity controlled by an injection molding apparatus is prepared, and whether an abnormality has occurred in the injection molding apparatus is detected based on whether a value of the quantity is within a range bounded by the plurality of waveforms indicated by the prepared reference waveform data (see JP-A-2020-146929).

JP-A-2020-146929 is an example of the related art.

However, in the technique disclosed in JP-A-2020-146929, it is required to prepare the reference waveform data in order to detect whether an abnormality has occurred in the injection molding apparatus, which may require time and effort. This is difficult to apply to, for example, high-mix low-volume production and production of prototypes for research, and thus is not desirable.

### SUMMARY

An aspect of the disclosure for solving the above problems provides a molding management system that manages production of a product in a production process including an injection molding process of the product by an injection molding apparatus, the molding management system including: an information processing apparatus communicably connected to a terminal apparatus, in which the information processing apparatus acquires, from the injection molding apparatus for each cycle in which injection molding is performed, cycle data including first quantity information indicating a value of a first quantity controlled by the injection molding apparatus during execution of the cycle, acquires, from the injection molding apparatus each time an injection molding condition is set in the injection molding apparatus, injection molding condition data including first target value information indicating a first target value that is a target value in control of the first quantity by the injection molding apparatus as one piece of injection molding condition information indicating the injection molding condition set in the injection molding apparatus in the cycle, and causes a display unit to display, based on first cycle data in the cycle data acquired from the injection molding apparatus and first injection molding condition data associated with the first cycle data in the acquired injection molding condition data in response to a received first operation, abnormality occurrence period information indicating at least a part of an abnormality occurrence period in which an abnormality occurs in a first cycle that is the cycle in the first cycle data.

### BRIEF DESCRIPTION OF THE DRAWINGS

FIG. 1 shows an example of a configuration of a molding management system 1.

FIG. 2 shows an example of a target value reception image P1.

FIG. 3 shows an example of an allowable range reception image P2.

FIG. 4 shows an example of an abnormality determination result image P3.

FIG. 5 shows an example of a first detailed information image P4.

FIG. 6 shows another example of the abnormality determination result image P3.

FIG. 7 shows an example of a second detailed information image P5.

FIG. 8 shows an example of a hardware configuration of an information processing apparatus X.

FIG. 9 shows an example of a functional configuration of the information processing apparatus X.

FIG. 10 shows an example of a flow of processing performed by the information processing apparatus X in response to a received operation.

### DESCRIPTION OF EMBODIMENTS

### Embodiments

An embodiment of the disclosure will be described below with reference to the drawings.

### Overview of Molding Management System

First, an overview of a molding management system according to the embodiment will be described.

The molding management system according to the embodiment manages production of a product in a production process including an injection molding process of the product by an injection molding apparatus. The molding management system includes an information processing apparatus. The information processing apparatus is communicably connected to a terminal apparatus. In addition, the information processing apparatus acquires, from the injection molding apparatus for each cycle in which injection molding is performed, cycle data including first quantity information indicating a value of a first quantity controlled by the injection molding apparatus during execution of the cycle. In addition, the information processing apparatus acquires, from the injection molding apparatus each time an injection molding condition is set in the injection molding apparatus, injection molding condition data including first target value information indicating a first target value that is a target value in control of the first quantity by the injection molding apparatus as one piece of injection molding condition information indicating the injection molding condition set in the injection molding apparatus in the cycle. Then, based on first cycle data in the cycle data acquired from the injection molding apparatus and first injection molding condition data associated with the first cycle data in the acquired injection molding condition data, the information processing apparatus causes, in response to a received first operation, a display unit to display abnormality occurrence period information indicating at least a part of an abnormality occurrence period in which an abnormality has occurred in a first cycle that is a cycle in the first cycle data. Accordingly, the molding management system can easily detect that an abnormality has occurred in the injection molding apparatus without preparing information other than the information acquired from the injection molding apparatus.

Hereinafter, a configuration of the molding management system according to such an embodiment and processing performed by a server provided in the molding management system will be described in detail.

### Configuration of Molding Management System

Hereinafter, the configuration of the molding management system according to the embodiment will be described, taking a molding management system 1 as an example.

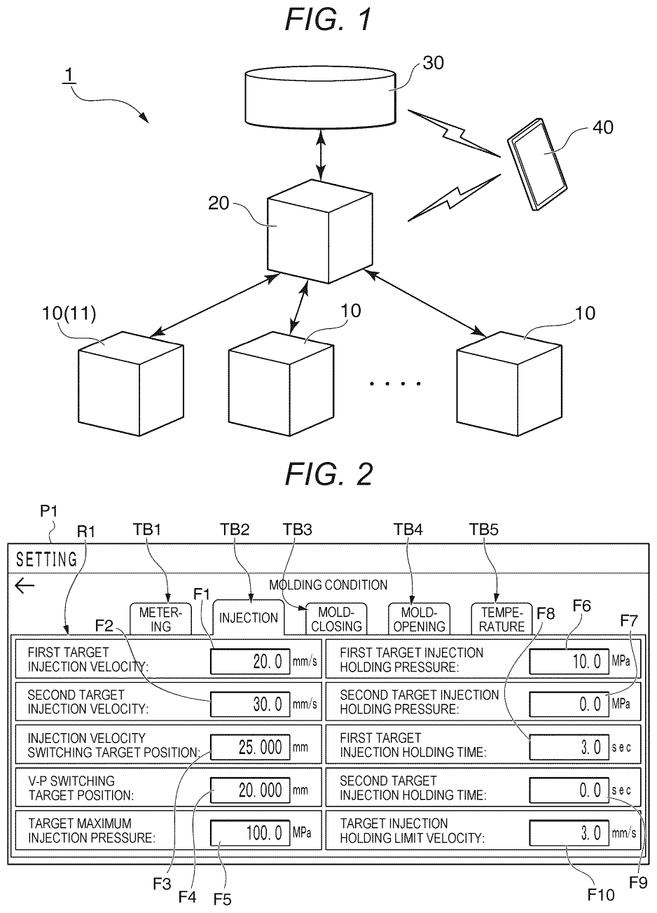

FIG. 1 shows an example of a configuration of the molding management system 1.

The molding management system 1 is a type of a manufacturing execution system (MES). For example, the molding management system 1 includes one or more managed apparatuses 10, an information processing apparatus 20, and a server 30. The molding management system 1 may not include a part or all of the one or more managed apparatuses 10. In addition, the molding management system 1 may include the server 30 without including the information processing apparatus 20. In addition, the molding management system 1 may include the information processing apparatus 20 without including the server 30. In addition, in the molding management system 1, the information processing apparatus 20 may be implemented integrally with the server 30. Hereinafter, as an example, a case will be described in which the molding management system 1 includes a plurality of managed apparatuses 10 as the one or more managed apparatuses 10. Hereinafter, as an example, a case will be described in which the molding management system 1 includes both the information processing apparatus 20 and the server 30 separate from the information processing apparatus 20. At least one of the information processing apparatus 20 and the server 30 is an example of the information processing apparatus.

Each of the plurality of managed apparatuses 10 provided in the molding management system 1 is an apparatus managed by the molding management system 1. In FIG. 1, for convenience of description, the plurality of managed apparatuses 10 are indicated by the same reference numeral. However, a part or all of the plurality of managed apparatuses 10 may be apparatuses of types different from one another. The plurality of managed apparatuses 10 include at least one injection molding apparatus that performs injection molding of a product using a resin such as plastic. An injection molding apparatus 11 shown in FIG. 1 is an example of such an injection molding apparatus. The plurality of managed apparatuses 10 may include an injection molding apparatus that performs metal injection molding (MIM) of a product. Hereinafter, for convenience of description, the injection molding of a product using a resin such as plastic is simply referred to as injection molding. Hereinafter, the injection molding apparatus that performs the injection molding of a product using a resin such as plastic is simply referred to as an injection molding apparatus. At least one injection molding apparatus in the plurality of managed apparatuses 10 may be an apparatus that performs injection molding using a material other than resins and metals. In addition to the injection molding apparatus, the plurality of managed apparatuses 10 include, for example, peripheral equipment of the injection molding apparatus. The peripheral equipment of the injection molding apparatus is, for example, a material supply apparatus, a conveying apparatus, a cleaning apparatus, or a sintering apparatus, and is not limited thereto. Here, the material supply apparatus is an apparatus that supplies, to the injection molding apparatus, a material used for the injection molding of the product by the injection molding apparatus. The conveying apparatus is an apparatus that conveys a product subjected to the injection molding by the injection molding apparatus. The cleaning apparatus is an apparatus that cleans the product subjected to the injection molding by the injection molding apparatus. The sintering apparatus is an apparatus that sinters the product after being cleaned by the cleaning apparatus.

The molding management system 1 manages production of the product in a production process including an injection molding process of the product by the injection molding apparatus in the plurality of managed apparatuses 10. Here, the injection molding apparatus in the plurality of managed apparatuses 10 may have any configuration as long as the configuration enables the production of the product by injection molding. Hereinafter, for convenience of description, a process in which the injection molding apparatus performs injection molding of the product once is referred to as a cycle. Hereinafter, for convenience of description, a cavity in a mold attached to the injection molding apparatus will be referred to as a cavity. That is, the injection molding apparatus injects the material into the cavity in the mold attached to the injection molding apparatus and applies a pressure to the material in the cavity to perform the injection molding of the product.

Here, one or more injection molding apparatuses in the plurality of managed apparatuses 10 include an extrusion unit that extrudes the material used for the injection molding of the product into the cavity in the mold attached to the injection molding apparatus in the injection molding process. The extrusion unit is, for example, a screw that moves a position in a cylinder forward and backward by rotating in the cylinder. Instead of the screw, the extrusion unit may be a member that moves the position in the cylinder forward and backward by a hydraulic pressure, a linear actuator, or the like. The material is extruded from an injection port of the cylinder toward the cavity in the mold according to forward movement of the extrusion unit in the cylinder. Hereinafter, for convenience of description, the extrusion unit in the injection molding apparatus will be referred to as a screw.

One or more detection units are attached to one or more injection molding apparatuses in the plurality of managed apparatuses 10. The one or more detection units detect a quantity controlled by the injection molding apparatus in each cycle. The quantity controlled by the injection molding apparatus in each cycle is, for example, a part or all of a screw position, an injection velocity that is a velocity at which the material is injected into the cavity in the mold by the screw, a screw rotation speed, an injection holding pressure that is the pressure in the mold held by the screw, and a temperature in the mold, but is not limited thereto. Hereinafter, for convenience of description, the quantity detected by each of one or more detection units attached to each of one or more injection molding apparatuses in the plurality of managed apparatuses 10 will be simply referred to as a detection quantity. A detection unit that detects a certain detection quantity among one or more detection units attached to a certain injection molding apparatus is, for example, a sensor that detects the detection quantity, but is not limited thereto. The one or more detection units may include a detection unit that detects quality of the product. This is because the quality of the product is also controlled by the injection molding apparatus in each cycle. In this case, the detection unit is, for example, a device including an imaging unit that can capture an image of the product to detect the quality of the product, but is not limited thereto. In this case, for example, a quantity indicating the quality of the product detected by the detection unit is, for example, any of a plurality of predetermined values arranged in descending order of quality, but is not limited thereto.

The information processing apparatus 20 acquires cycle data for each cycle from each of the one or more injection molding apparatuses in the plurality of managed apparatuses 10. More specifically, the information processing apparatus 20 acquires the cycle data from each of the one or more injection molding apparatuses each time each cycle ends. Hereinafter, for convenience of description, cycle data acquired when a certain cycle ends will be referred to as cycle data of the cycle. Hereinafter, for convenience of description, a cycle that ends when certain cycle data is acquired will be referred to as a cycle of the cycle data.

The cycle data acquired from a certain injection molding apparatus in a certain cycle is information including one or more pieces of cycle-related information obtained in response to execution of the cycle by the injection molding apparatus, apparatus identification information for identifying the injection molding apparatus, and first date-and-time information indicating date and time of acquisition by the information processing apparatus 20 from the injection molding apparatus. The apparatus identification information is, for example, an identifier (ID) for identifying the injection molding apparatus, and may alternatively be other information through which the injection molding apparatus can be identified, such as an Internet protocol (IP) address assigned to the injection molding apparatus. The first date-and-time information may be a time stamp or other information indicating the date and time. The cycle data may include other information in addition to the one or more pieces of cycle-related information, the apparatus identification information, and the first date-and-time information. The apparatus identification information may be contained in the cycle data as any one of the one or more pieces of cycle-related information. Hereinafter, as an example, a case will be described in which the apparatus identification information is contained in the cycle data as any one of the one or more pieces of cycle-related information.

The one or more pieces of cycle-related information in the cycle data acquired from the certain injection molding apparatus in the certain cycle include one or more pieces of detection quantity information in addition to the apparatus identification information for identifying the injection molding apparatus. Each of the one or more pieces of detection quantity information is information indicating a value of each detection quantity controlled by the injection molding apparatus. Detection quantity information indicating a value of a certain detection quantity includes time-series information indicating a time series of the detection quantity and feature value information indicating one or more types of feature values for the detection quantity. Here, the one or more types of feature values for the certain detection quantity are, for example, at least one of a minimum value, a maximum value, an average value, a variance, and a standard deviation of the detection quantity, a start value of a period in which the detection quantity is detected, and an end value of the period. That is, the one or more types of feature values are values indicating features of a waveform indicating a change over time in the detection quantity. The one or more types of feature values may include another value obtained by performing statistical processing on the detection quantity, instead of a part or all of the feature values or in addition to all of the feature values. The feature value information may be contained in the detection quantity information in the injection molding apparatus or the information processing apparatus 20. This is because the information processing apparatus 20 can calculate the one or more types of feature values based on the time-series information.

The detection quantity information may not include the time-series information as long as the feature value information is contained. Hereinafter, as an example, a case will be described in which both the time-series information and the feature value information are contained in the detection quantity information. The feature value information may be the time-series information. This is also because the information processing apparatus 20 can calculate the one or more types of feature values based on the time-series information.

The one or more pieces of cycle-related information in the cycle data acquired from the certain injection molding apparatus in the certain cycle may include other information in addition to the apparatus identification information and one or more pieces of feature value information. The other information is, for example, a part or all of operation state information and product count information, but is not limited thereto. Here, the operation state information contained in the cycle data as the cycle-related information is information indicating an operation state of the injection molding apparatus. The product count information contained in the cycle data as the cycle-related information is information indicating the number of products injection-molded by the injection molding apparatus in the cycle.

The cycle data as described above can be distinguished by a combination of the apparatus identification information and the first date-and-time information. When there is only one injection molding apparatus coupled to the information processing apparatus 20, the cycle data may not include the apparatus identification information. This is because, in this case, each piece of cycle data can be distinguished by the first date-and-time information alone.

When a certain piece of cycle data is acquired, the information processing apparatus 20 stores the acquired cycle data and outputs the acquired cycle data to the server 30. Accordingly, the information processing apparatus 20 can also store the acquired cycle data in the server 30.

The information processing apparatus 20 acquires injection molding condition data from each of the one or more injection molding apparatuses in the plurality of managed apparatuses 10 each time an injection molding condition is set in the injection molding apparatus.

Here, the injection molding condition data acquired from the certain injection molding apparatus is information in which one or more pieces of injection molding condition information each indicating the injection molding condition set in the injection molding apparatus, the apparatus identification information for identifying the injection molding apparatus, and second date-and-time information indicating date and time of acquisition by the information processing apparatus 20 from the injection molding apparatus are associated with one another. The apparatus identification information is, for example, an ID for identifying the injection molding apparatus, and may alternatively be other information through which the injection molding apparatus can be identified, such as an IP address assigned to the injection molding apparatus. The second date-and-time information may be a time stamp or other information indicating the date and time. The injection molding condition data may include other information in addition to the one or more pieces of injection molding condition information, the apparatus identification information, and the second date-and-time information. The apparatus identification information may be contained in the injection molding condition data as any one of the one or more pieces of injection molding condition information. Hereinafter, as an example, a case will be described in which the apparatus identification information is contained in the injection molding condition data as any one of the one or more pieces of injection molding condition information.

The one or more pieces of injection molding condition information in the injection molding condition data acquired from the certain injection molding apparatus include one or more pieces of target value information in addition to the apparatus identification information for identifying the injection molding apparatus. Each of the one or more pieces of target value information is information indicating one or more target values in control for each detection quantity by the injection molding apparatus. Therefore, target value information indicating one or more target values for a certain detection quantity is associated with the detection quantity. A method for associating the detection quantity with the target value information may be a known method or a method to be developed. A reason why the one or more pieces of target value information are contained in the injection molding condition data as the injection molding condition information is that the injection molding apparatus controls the detection quantity such that the value of the detection quantity matches the target value of the detection quantity for each detection quantity in each cycle. Here, a reason why the target value for each detection quantity is one or more is that there may be a plurality of target values as targets to which each detection quantity is to be brought close in control by the injection molding apparatus in each cycle. For example, the injection velocity, which is the velocity at which the material is injected into the cavity in the mold by the screw, changes in a plurality of stages in an injection molding process in each cycle. In such a case, there are a plurality of target values for the detection quantity. The target value information for the certain detection quantity indicates each of the one or more target values for the detection quantity. Therefore, the injection molding condition data includes, as the injection molding condition information, each of a number of pieces of target value information equal to the number of detection units attached to the injection molding apparatus. Hereinafter, for convenience of description, each of the one or more target values for the certain detection quantity will be referred to as a target value corresponding to the detection quantity. Therefore, hereinafter, for convenience of description, the detection quantity will be referred to as a detection quantity corresponding to the one or more target values.

The one or more pieces of injection molding condition information in the injection molding condition data acquired from the certain injection molding apparatus include abnormality determination condition information associated with each target value set as the injection molding condition in the injection molding apparatus, in addition to the apparatus identification information for identifying the injection molding apparatus and the one or more pieces of target value information. The abnormality determination condition information associated with a certain target value is information indicating an abnormality determination condition satisfied by a value of a detection quantity corresponding to the target value when no abnormality occurs in the value of the detection quantity in control in which the injection molding apparatus causes the value of the detection quantity to match the target value. A method for associating the target value with the abnormality determination condition information may be a known method or a method to be developed. The abnormality determination condition may be any condition as long as the condition is satisfied by the value of the detection quantity when no abnormality occurs in the value of the detection quantity in the control.

Here, the abnormality determination condition information will be described using examples of abnormality determination condition information X3 associated with a certain target value X2 corresponding to a certain detection quantity X1 and an injection molding apparatus X4 that performs control for causing a value of the detection quantity X1 to match the target value X2. In the control in which the injection molding apparatus X4 causes the value of the detection quantity X1 to match the target value X2, occurrence of an abnormality in the value of the detection quantity X1 means that product quality deteriorates in a cycle executed by the injection molding apparatus X4 or an abnormality occurs in the injection molding apparatus X4 in the cycle. Whether such an abnormality occurs can be determined based on whether the value of the detection quantity X1 deviates from an allowable range for deviation of the value of the detection quantity X1 from the target value X2 in the control in which the injection molding apparatus X4 causes the value of the detection quantity X1 to match the target value X2. In this case, the abnormality determination condition indicated by the abnormality determination condition information X3 is that the value of the detection quantity X1 does not deviate from the allowable range for the deviation of the value of the detection quantity X1 from the target value X2 in the control in which the injection molding apparatus X4 causes the value of the detection quantity X1 to match the target value X2. In this case, the information processing apparatus 20 determines that no abnormality occurs in the value of the detection quantity X1 when the value of the detection quantity X1 does not deviate from the allowable range for the deviation of the value of the detection quantity X1 from the target value X2 in the control in which the injection molding apparatus X4 causes the value of the detection quantity X1 to match the target value X2. On the other hand, in this case, the information processing apparatus 20 determines that an abnormality occurs in the value of the detection quantity X1 when the value of the detection quantity X1 deviates from the allowable range for the deviation of the value of the detection quantity X1 from the target value X2 in the control in which the injection molding apparatus X4 causes the value of the detection quantity X1 to match the target value X2. When a width of the allowable range for the deviation of the value of the detection quantity X1 from the target value X2 is 0, the deviation of the value of the detection quantity X1 from the allowable range may mean, for example, that the value of the detection quantity X1 exceeds the target value X2, that the value of the detection quantity X1 falls below the target value X2, or another event corresponding to a difference between the value of the detection quantity X1 and the target value X2. In other words, when the width of the allowable range for the deviation of the value of the detection quantity X1 from the target value X2 is 0, the fact that the value of the detection quantity X1 does not deviate from the allowable range may mean, for example, that the value of the detection quantity X1 does not exceed the target value X2, that the value of the detection quantity X1 does not fall below the target value X2, or another event corresponding to the difference between the value of the detection quantity X1 and the target value X2. Hereinafter, for convenience of description, an allowable range for deviation of a value of a certain detection quantity from a target value corresponding to the detection quantity will be referred to as an allowable range for the target value.

In this way, the abnormality determination condition indicated by the abnormality determination condition information X3 associated with the target value X2 is a value used for monitoring the deviation of the value of the detection quantity X1 from the target value X2. Therefore, it can be said that the abnormality determination condition is a monitoring condition received for monitoring a change over time in the detection quantity X1 to prevent product quality deterioration or abnormality occurrence in the injection molding apparatus X4.

Whether the value of the detection quantity X1 deviates from the allowable range for the target value X2 is required to be determined using a time series of the value of the detection quantity X1. However, this determination method is not a desirable method from the viewpoint of reducing a processing load on the information processing apparatus 20 since information indicating the time series is required to be read each time the determination is performed.

Therefore, for example, in the control in which the injection molding apparatus X4 causes the value of the detection quantity X1 to match the target value X2, the information processing apparatus 20 may determine whether an abnormality occurs in the value of the detection quantity X1 based on at least one feature value among one or more types of feature values for the detection quantity X1 and an allowable range for the at least one feature value. Here, an allowable range for a certain feature value among the one or more types of feature values is a range determined such that the value of the detection quantity X1 does not deviate from the allowable range for the target value X2 when the feature value does not deviate from the allowable range for the feature value, and such that the value of the detection quantity X1 deviates from the allowable range for the target value X2 when the feature value deviates from the allowable range for the feature value. For example, an allowable range for a maximum value or an average value of the detection quantity X1 is an example of the range determined in this way. Accordingly, the allowable range for the feature value is equivalent to the allowable range for the target value. The same applies to other feature values among the one or more types of feature values. Therefore, hereinafter, for convenience of description, deviation of the certain feature value from the allowable range for the feature value is referred to as occurrence of an abnormality in the feature value. Hereinafter, as an example, each of one or more types of feature values for a detection quantity corresponding to a certain target value will be described as a feature value corresponding to the target value. For the reasons described above, as an example, a case will be described below in which the information processing apparatus 20 determines whether an abnormality occurs in the value of the detection quantity X1 based on whether an abnormality occurs in at least one feature value among one or more types of feature values for the detection quantity X1 in the control in which the injection molding apparatus X4 causes the value of the detection quantity X1 to match the target value X2.

The one or more pieces of injection molding condition information in the injection molding condition data acquired from the certain injection molding apparatus may include other information in addition to the apparatus identification information for identifying the injection molding apparatus, the one or more pieces of target value information, and the abnormality determination condition information associated with each target value set as the injection molding condition in the injection molding apparatus.

The injection molding condition data as described above can be distinguished by a combination of the apparatus identification information and the second date-and-time information. When there is only one injection molding apparatus coupled to the information processing apparatus 20, the injection molding condition data may not include the apparatus identification information. This is because, in this case, each piece of injection molding condition data can be distinguished by the second date-and-time information alone.

When a certain piece of injection molding condition data is acquired, the information processing apparatus 20 stores the acquired injection molding condition data and outputs the acquired injection molding condition data to the server 30. Accordingly, the information processing apparatus 20 can also store the acquired injection molding condition data in the server 30. Here, the information processing apparatus 20 associates the injection molding condition data indicating the injection molding condition set in the certain injection molding apparatus in the certain cycle with the cycle data acquired from the injection molding apparatus in the cycle. Such an association method may be a known method or may be a method to be developed. By such association, at least one piece of injection molding condition data is associated with each piece of cycle data. Hereinafter, as an example, a case will be described in which one piece of injection molding condition data is associated with each piece of cycle data.

In response to a request from the terminal apparatus communicably connected to the information processing apparatus 20, the information processing apparatus 20 causes a display unit of the terminal apparatus to display various images based on data stored in the information processing apparatus 20. Here, the images are a graphical user interface (GUI), an icon, a window on an operating system (OS), and the like. Hereinafter, as an example, a case will be described in which the information processing apparatus 20 is communicably connected to a terminal apparatus 40 as shown in FIG. 1. In the embodiment, since processing related to login to the information processing apparatus 20 by the terminal apparatus 40 is known processing, a description thereof will be omitted. Hereinafter, for convenience of description, the information processing apparatus 20 receiving an operation from the terminal apparatus 40 via an image displayed on the terminal apparatus 40 is simply referred to as the information processing apparatus 20 receiving an operation. That is, hereinafter, the information processing apparatus 20 performing certain processing in response to a received operation means the information processing apparatus 20 performing the processing in response to the operation received from the terminal apparatus 40 via the image displayed on the terminal apparatus 40.

The information processing apparatus 20 is, for example, a workstation, a desktop personal computer (PC), or a notebook PC, but is not limited thereto. The information processing apparatus 20 is communicably connected to each of the plurality of managed apparatuses 10 by wired or wireless communication. A communication network that connects the information processing apparatus 20 and each of the plurality of managed apparatuses 10 is, for example, a local area network (LAN) in a facility where the plurality of managed apparatuses 10 are provided, but is not limited thereto. The communication network may be another communication network such as the Internet or a mobile communication network.

The server 30 stores the cycle data acquired by the information processing apparatus 20. For example, when a certain piece of cycle data is acquired from the information processing apparatus 20, the server 30 stores the acquired cycle data.

The server 30 stores the injection molding condition data acquired by the information processing apparatus 20. For example, when a certain piece of injection molding condition data is acquired from the information processing apparatus 20, the server 30 stores the acquired injection molding condition data.

In response to a request from the terminal apparatus communicably connected to the server 30, the server 30 causes the display unit of the terminal apparatus to display various images based on data stored in the server 30. Here, the images are a GUI, an icon, a window on an OS, and the like. Hereinafter, as an example, a case will be described in which the server 30 is communicably connected to the terminal apparatus 40 as shown in FIG. 1. In the embodiment, since processing related to login to the server 30 by the terminal apparatus 40 is known processing, a description thereof will be omitted. Hereinafter, for convenience of description, the server 30 receiving an operation from the terminal apparatus 40 via an image displayed on the terminal apparatus 40 is simply referred to as the server 30 receiving an operation. That is, hereinafter, the server 30 performing certain processing in response to a received operation means the server 30 performing the processing in response to the operation received from the terminal apparatus 40 via the image displayed on the terminal apparatus 40.

As described above, in the molding management system 1, both the information processing apparatus 20 and the server 30 cause the display unit of the terminal apparatus 40 to display, in response to the received operation, the various images based on the stored data. Therefore, hereinafter, for convenience of description, the information processing apparatus 20 and the server 30 are collectively referred to as an information processing apparatus X unless it is required to distinguish therebetween. The display unit is, for example, the display of the terminal apparatus 40 or a display apparatus communicably connected to the terminal apparatus 40, but is not limited thereto. Hereinafter, as an example, a case will be described in which the display unit is the display of the terminal apparatus 40. Hereinafter, for convenience of description, displaying a certain image on the display unit is referred to as displaying the image.

Here, the information processing apparatus X displays a target value reception image P1 for an injection molding apparatus specified by a received target value reception image display operation according to the target value reception image display operation. The target value reception image P1 is an image for receiving one or more target values corresponding to the detection quantity detected by each detection unit attached to the injection molding apparatus. Hereinafter, for convenience of description, the injection molding apparatus specified according to the target value reception image display operation will be referred to as a first target injection molding apparatus. The target value reception image display operation may be any operation.

FIG. 2 shows an example of the target value reception image P1. In the example shown in FIG. 2, the target value reception image P1 includes a region R1, five tabs including a tab TB1 to a tab TB5, and ten input fields including an input field F1 to an input field F10. The target value reception image P1 may include another GUI that can receive one or more target values corresponding to the detection quantity detected by each detection unit attached to the first target injection molding apparatus instead of a part or all of these graphical user interfaces (GUIs) or in addition to all of these GUIs.

The region R1 is a region where an input field for receiving the target value is displayed.

The tab TB1 is a GUI that receives an operation of causing the region R1 to display an input field for receiving each of one or more target values corresponding to a detection quantity related to a metering process among processes in each cycle. When a selection operation is performed on the tab TB1, the information processing apparatus X causes the region R1 to display the input field for receiving each of the one or more target values corresponding to the detection quantity related to the metering process. In the embodiment, for example, the selection operation is a click or a tap, but is not limited thereto.

The tab TB2 is a GUI that receives an operation of causing the region R1 to display an input field for receiving each of one or more target values corresponding to a detection quantity related to an injection process among processes in each cycle. When a selection operation is performed on the tab TB2, the information processing apparatus X causes the region R1 to display the input field for receiving each of the one or more target values corresponding to the detection quantity related to the injection process. In the embodiment, for example, the selection operation is a click or a tap, but is not limited thereto. In the example shown in FIG. 2, an input field for receiving each of ten target values corresponding to the detection quantity related to the injection process is displayed in the region R1. Specifically, in this example, in the region R1, ten input fields including the input field F1 to the input field F10 are displayed.

The tab TB3 is a GUI that receives an operation of causing the region R1 to display an input field for receiving each of one or more target values corresponding to a detection quantity related to a mold closing process among processes in each cycle. When a selection operation is performed on the tab TB3, the information processing apparatus X causes the region R1 to display the input field for receiving each of the one or more target values corresponding to the detection quantity related to the mold closing process. In the embodiment, for example, the selection operation is a click or a tap, but is not limited thereto.

The tab TB4 is a GUI that receives an operation of causing the region R1 to display an input field for receiving each of one or more target values corresponding to a detection quantity related to a mold opening process among processes in each cycle. When a selection operation is performed on the tab TB4, the information processing apparatus X causes the region R1 to display the input field for receiving each of the one or more target values corresponding to the detection quantity related to the mold opening process.

The tab TB5 is a GUI that receives an operation of causing the region R1 to display an input field for receiving each of one or more target values corresponding to a detection quantity related to a temperature. When a selection operation is performed on the tab TB5, the information processing apparatus X causes the region R1 to display the input field for receiving each of the one or more target values corresponding to the detection quantity related to the temperature.

The input field F1 is a field for receiving a first target injection velocity that is a target value corresponding to the injection velocity at which the material is injected into the mold. Here, the injection velocity is an example of the detection quantity related to the injection process. The first target injection velocity is a target value for the injection velocity in a first half of velocity control for changing the screw position such that the injection velocity is kept constant. In the example shown in FIG. 2, “20.0” is received by the input field F1 as an example of the first target injection velocity. When the first target injection velocity is received by the input field F1, the information processing apparatus X specifies the first target injection velocity received by the input field F1 as the injection molding condition for the injection velocity in the first half of the velocity control, and outputs the injection molding condition information indicating the specified injection molding condition to the first target injection molding apparatus. Accordingly, the information processing apparatus X can set the first target injection velocity in the first target injection molding apparatus as one injection molding condition for the injection velocity. In the example shown in FIG. 2, the information processing apparatus X specifies 20.0 mm/s, which is an example of the first target injection velocity, as the injection molding condition for the injection velocity, and outputs the injection molding condition information indicating the specified injection molding condition to the first target injection molding apparatus. A value may be input to the input field F1 by selecting the value from a pull-down menu, or may be directly input using an input apparatus such as a keyboard.

The input field F2 is a field for receiving a second target injection velocity that is a target value corresponding to the injection velocity at which the material is injected into the mold. The second target injection velocity is a target value for the injection velocity in a latter half of the velocity control for changing the screw position such that the injection velocity is kept constant. In the example shown in FIG. 2, “30.0” is received by the input field F2 as an example of the second target injection velocity. When the second target injection velocity is received by the input field F2, the information processing apparatus X specifies the second target injection velocity received by the input field F2 as the injection molding condition for the injection velocity in the latter half of the velocity control, and outputs the injection molding condition information indicating the specified injection molding condition to the first target injection molding apparatus. Accordingly, the information processing apparatus X can set the second target injection velocity in the first target injection molding apparatus as one injection molding condition for the injection velocity. In the example shown in FIG. 2, the information processing apparatus X specifies 30.0 mm/s, which is an example of the second target injection velocity, as the injection molding condition for the injection velocity, and outputs the injection molding condition information indicating the specified injection molding condition to the first target injection molding apparatus. A value may be input to the input field F2 by selecting the value from a pull-down menu, or may be directly input using an input apparatus such as a keyboard.

The input field F3 is a field for receiving an injection velocity switching target position that is a target value corresponding to an injection velocity switching position that is a screw position when the injection velocity at which the material is injected into the mold is switched from the first target injection velocity to the second target injection velocity. Here, the injection velocity switching position is an example of the detection quantity related to the injection process. In the example shown in FIG. 2, “25.000” is received by the input field F3 as an example of the injection velocity switching target position. When the injection velocity switching target position is received by the input field F3, the information processing apparatus X specifies the injection velocity switching target position received by the input field F3 as the injection molding condition for the injection velocity switching position, and outputs the injection molding condition information indicating the specified injection molding condition to the first target injection molding apparatus. Accordingly, the information processing apparatus X can set the injection velocity switching target position in the first target injection molding apparatus as one injection molding condition for the injection velocity switching position. In the example shown in FIG. 2, the information processing apparatus X specifies 25.000 mm, which is an example of the injection velocity switching target position, as the injection molding condition for the injection velocity switching position, and outputs the injection molding condition information indicating the specified injection molding condition to the first target injection molding apparatus. A value may be input to the input field F3 by selecting the value from a pull-down menu, or may be directly input using an input apparatus such as a keyboard.

The input field F4 is a field for receiving a V-P switching target position that is a target value corresponding to a V-P switching position, which is a screw position when control for changing the screw position is switched from the velocity control to pressure control. Here, the V-P switching position is an example of the detection quantity related to the injection process. In the example shown in FIG. 2, “20.000” is received by the input field F4 as an example of the V-P switching target position. When the V-P switching target position is received by the input field F4, the information processing apparatus X specifies the V-P switching target position received by the input field F4 as the injection molding condition for the V-P switching position, and outputs the injection molding condition information indicating the specified injection molding condition to the first target injection molding apparatus. Accordingly, the information processing apparatus X can set the V-P switching target position in the first target injection molding apparatus as one injection molding condition for the V-P switching position. In the example shown in FIG. 2, the information processing apparatus X specifies 20.000 mm, which is an example of the V-P switching target position, as the injection molding condition for the V-P switching position, and outputs the injection molding condition information indicating the specified injection molding condition to the first target injection molding apparatus. A value may be input to the input field F4 by selecting the value from a pull-down menu, or may be directly input using an input apparatus such as a keyboard.

The input field F5 is a field for receiving a target maximum injection pressure that is a target value corresponding to a maximum injection pressure that is a maximum pressure in the mold in a process of injecting the material into the mold. Here, the maximum injection pressure is an example of the detection quantity related to the injection process. In the example shown in FIG. 2, “100.0” is received by the input field F5 as an example of the target maximum injection pressure. When the target maximum injection pressure is received by the input field F5, the information processing apparatus X specifies the target maximum injection pressure received by the input field F5 as the injection molding condition for the maximum injection pressure, and outputs the injection molding condition information indicating the specified injection molding condition to the first target injection molding apparatus. Accordingly, the information processing apparatus X can set the target maximum injection pressure in the first target injection molding apparatus as one injection molding condition for the maximum injection pressure. In the example shown in FIG. 2, the information processing apparatus X specifies 100.0 MPa, which is an example of the target maximum injection pressure, as the injection molding condition for the maximum injection pressure, and outputs the injection molding condition information indicating the specified injection molding condition to the first target injection molding apparatus. A value may be input to the input field F5 by selecting the value from a pull-down menu, or may be directly input using an input apparatus such as a keyboard.

The input field F6 is a field for receiving a first target injection holding pressure that is a target value corresponding to an injection holding pressure, which is a pressure in pressure control for changing the screw position such that the pressure in the mold is kept constant. Here, the injection holding pressure is an example of the detection quantity related to the injection process. The first target injection holding pressure is the pressure in a first half of the pressure control for changing the screw position such that the pressure in the mold is kept constant. In the example shown in FIG. 2, “10.0” is received by the input field F6 as an example of the first target injection holding pressure. When the first target injection holding pressure is received by the input field F6, the information processing apparatus X specifies the first target injection holding pressure received by the input field F6 as the injection molding condition for the injection holding pressure, and outputs the injection molding condition information indicating the specified injection molding condition to the first target injection molding apparatus. Accordingly, the information processing apparatus X can set the first target injection holding pressure in the first target injection molding apparatus as one injection molding condition for the injection holding pressure. In the example shown in FIG. 2, the information processing apparatus X specifies 10.0 MPa, which is an example of the first target injection holding pressure, as the injection molding condition for the injection holding pressure, and outputs the injection molding condition information indicating the specified injection molding condition to the first target injection molding apparatus. A value may be input to the input field F6 by selecting the value from a pull-down menu, or may be directly input using an input apparatus such as a keyboard.

The input field F7 is a field for receiving a second target injection holding pressure that is a target value corresponding to the injection holding pressure, which is the pressure in the pressure control for changing the screw position such that the pressure in the mold is kept constant. The second target injection holding pressure is the pressure in a latter half of the pressure control for changing the screw position such that the pressure in the mold is kept constant. In the example shown in FIG. 2, “0.0” is received by the input field F7 as an example of the second target injection holding pressure. When the second target injection holding pressure is received by the input field F7, the information processing apparatus X specifies the second target injection holding pressure received by the input field F7 as the injection molding condition for the injection holding pressure, and outputs the injection molding condition information indicating the specified injection molding condition to the first target injection molding apparatus. Accordingly, the information processing apparatus X can set the second target injection holding pressure in the first target injection molding apparatus as one injection molding condition for the injection holding pressure. In the example shown in FIG. 2, the information processing apparatus X specifies 0.0 MPa, which is an example of the second target injection holding pressure, as the injection molding condition for the injection holding pressure, and outputs the injection molding condition information indicating the specified injection molding condition to the first target injection molding apparatus. A value may be input to the input field F7 by selecting the value from a pull-down menu, or may be directly input using an input apparatus such as a keyboard.

The input field F8 is a field for receiving a first target injection holding time that is a target value corresponding to an injection holding time, which is a duration of the pressure control for changing the screw position such that the pressure in the mold is kept constant. Here, the injection holding time is an example of the detection quantity related to the injection process. The first target injection holding time is a duration of the first half of the pressure control for changing the screw position such that the pressure in the mold is kept constant. In the example shown in FIG. 2, “3.0” is received by the input field F8 as an example of the first target injection holding time. When the first target injection holding time is received by the input field F8, the information processing apparatus X specifies the first target injection holding time received by the input field F8 as the injection molding condition for the injection holding time, and outputs the injection molding condition information indicating the specified injection molding condition to the first target injection molding apparatus. Accordingly, the information processing apparatus X can set the first target injection holding time in the first target injection molding apparatus as one injection molding condition for the injection holding time. In the example shown in FIG. 2, the information processing apparatus X specifies 3.0 sec, which is an example of the first target injection holding time, as the injection molding condition for the injection holding time, and outputs the injection molding condition information indicating the specified injection molding condition to the first target injection molding apparatus. A value may be input to the input field F8 by selecting the value from a pull-down menu, or may be directly input using an input apparatus such as a keyboard.

The input field F9 is a field for receiving a second target injection holding time that is a target value corresponding to the injection holding time, which is the duration of the pressure control for changing the screw position such that the pressure in the mold is kept constant. The second target injection holding time is a duration of the latter half of the pressure control for changing the screw position such that the pressure in the mold is kept constant. In the example shown in FIG. 2, “0.0” is received by the input field F9 as an example of the second target injection holding time. When the second target injection holding time is received by the input field F9, the information processing apparatus X specifies the second target injection holding time received by the input field F9 as the injection molding condition for the injection holding time, and outputs the injection molding condition information indicating the specified injection molding condition to the first target injection molding apparatus. Accordingly, the information processing apparatus X can set the second target injection holding time in the first target injection molding apparatus as one injection molding condition for the injection holding time. In the example shown in FIG. 2, the information processing apparatus X specifies 0.0 sec, which is an example of the second target injection holding time, as the injection molding condition for the injection holding time, and outputs the injection molding condition information indicating the specified injection molding condition to the first target injection molding apparatus. A value may be input to the input field F9 by selecting the value from a pull-down menu, or may be directly input using an input apparatus such as a keyboard.

The input field F10 is a field for receiving a target injection holding limit velocity that is a target value corresponding to an injection holding limit velocity that is a limit velocity for changing the screw position in the pressure control for changing the screw position such that the pressure in the mold is kept constant. Here, the injection holding limit velocity is an example of the detection quantity related to the injection process. In the example shown in FIG. 2, “3.0” is received by the input field F10 as an example of the target injection holding limit velocity. When the target injection holding limit velocity is received by the input field F10, the information processing apparatus X specifies the target injection holding limit velocity received by the input field F10 as the injection molding condition for the injection holding limit velocity, and outputs the injection molding condition information indicating the specified injection molding condition to the first target injection molding apparatus. Accordingly, the information processing apparatus X can set the target injection holding limit velocity in the first target injection molding apparatus as one injection molding condition for the injection holding limit velocity. In the example shown in FIG. 2, the information processing apparatus X specifies 3.0 mm/s, which is an example of the target injection holding limit velocity, as the injection molding condition for the injection holding limit velocity, and outputs the injection molding condition information indicating the specified injection molding condition to the first target injection molding apparatus. A value may be input to the input field F10 by selecting the value from a pull-down menu, or may be directly input using an input apparatus such as a keyboard.

The information processing apparatus X can receive one or more target values for each detection quantity detected from the first target injection molding apparatus via the target value reception image P1 as described above. Meanwhile, the information processing apparatus X displays an allowable range reception image P2 for the first target injection molding apparatus in response to a received allowable range reception image display operation. The allowable range reception image P2 is an image for receiving an allowable range for each feature value corresponding to the target value for each of all target values received via the target value reception image P1. The allowable range reception image display operation may be any operation. The allowable range reception image display is an example of a fourth operation.

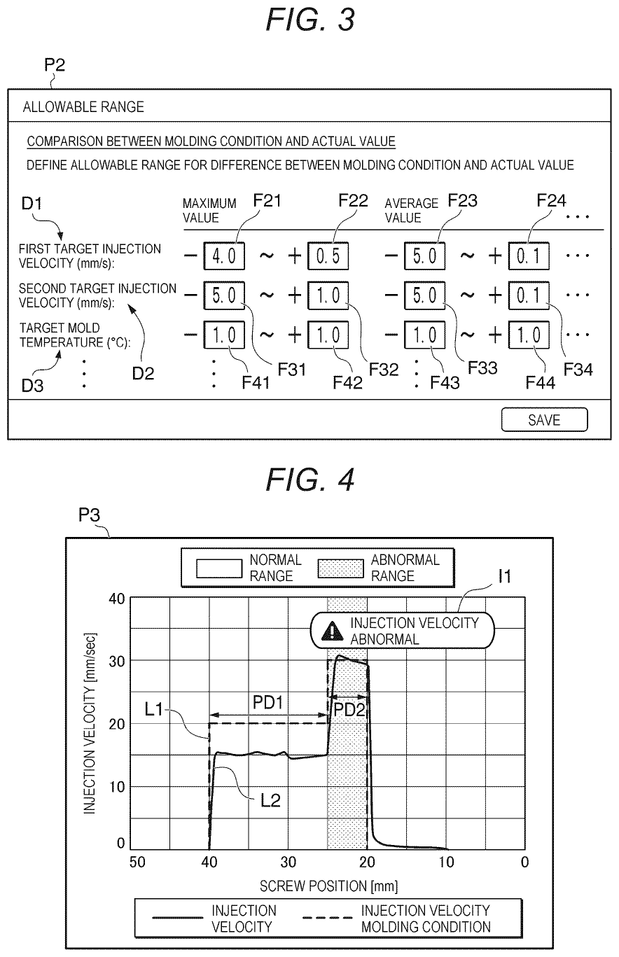

FIG. 3 shows an example of the allowable range reception image P2. In the example shown in FIG. 3, the allowable range reception image P2 includes, for each of all the target values received via the target value reception image P1, a combination of information indicating the target value and an input field for receiving the allowable range for each feature value corresponding to the target value. In FIG. 3, in order to simplify the drawing, combinations other than a combination of three target values, that is, the first target injection velocity, the second target injection velocity, and a target mold temperature, are omitted. In FIG. 3, in order to simplify the drawing, input fields other than input fields for receiving allowable ranges of two feature values, that is, a maximum value and an average value, are omitted. Therefore, in FIG. 3, the allowable range reception image P2 includes information D1, four input fields including an input field F21 to an input field F24, information D2, four input fields including an input field F31 to an input field F34, information D3, and four input fields including an input field F41 to an input field F44.

The information D1 is information indicating the first target injection velocity that is one target value received via the target value reception image P1.

The input field F21 and the input field F22 are input fields for receiving the allowable range for the maximum value that is one feature value corresponding to the first target injection velocity indicated by the information D1. Specifically, the input field F21 is an input field for receiving a lower limit value of the allowable range. In the example shown in FIG. 3, the lower limit value is represented as a value indicating a deviation in a negative direction on a number line from the first target injection velocity. In this example, “4.0” is received by the input field F21 as an example of the lower limit value. This means that the lower limit value is a value smaller than the first target injection velocity by 4.0 mm/s. When the lower limit value is received by the input field F21, the information processing apparatus X specifies the lower limit value received by the input field F21 as the lower limit value of the allowable range. Meanwhile, the input field F22 is an input field for receiving an upper limit value of the allowable range. In this example, the upper limit value is represented as a value indicating a deviation in a positive direction on the number line from the first target injection velocity. In this example, “0.5” is received by the input field F22 as an example of the upper limit value. This means that the upper limit value is a value larger than the first target injection velocity by 0.5 mm/s. When the upper limit value is received by the input field F22, the information processing apparatus X specifies the upper limit value received by the input field F22 as the upper limit value of the allowable range. Upon specifying the lower limit value and the upper limit value, the information processing apparatus X specifies a range from the specified lower limit value to the specified upper limit value as the allowable range. In this example, the information processing apparatus X specifies a range of −4.0 mm/s to 0.5 mm/s as the allowable range for the maximum value that is one feature value corresponding to the first target injection velocity indicated by the information D1. When no value is received by both the input field F21 and the input field F22, the information processing apparatus X determines that the allowable range for the maximum value, which is one feature value corresponding to the first target injection velocity indicated by the information D1, is not specified. In this case, the information processing apparatus X does not use the allowable range to determine whether an abnormality has occurred in a value of a detection quantity corresponding to the first target injection velocity. In addition, a value may be input to each of the input field F21 and the input field F22 by selecting the value from a pull-down menu, or may be directly input using an input apparatus such as a keyboard.

The input field F23 and the input field F24 are input fields for receiving the allowable range for the average value that is one feature value corresponding to the first target injection velocity indicated by the information D1. Specifically, the input field F23 is an input field for receiving a lower limit value of the allowable range. In the example shown in FIG. 3, the lower limit value is represented as a value indicating a deviation in a negative direction on a number line from the first target injection velocity. In this example, “5.0” is received by the input field F23 as an example of the lower limit value. This means that the lower limit value is a value smaller than the first target injection velocity by 5.0 mm/s. When the lower limit value is received by the input field F23, the information processing apparatus X specifies the lower limit value received by the input field F23 as the lower limit value of the allowable range. Meanwhile, the input field F24 is an input field for receiving an upper limit value of the allowable range. In this example, the upper limit value is represented as a value indicating a deviation in a positive direction on the number line from the first target injection velocity. In this example, “0.1” is received by the input field F24 as an example of the upper limit value. This means that the upper limit value is a value larger than the first target injection velocity by 0.1 mm/s. When the upper limit value is received by the input field F24, the information processing apparatus X specifies the upper limit value received by the input field F24 as the upper limit value of the allowable range. Upon specifying the lower limit value and the upper limit value, the information processing apparatus X specifies a range from the specified lower limit value to the specified upper limit value as the allowable range. In this example, the information processing apparatus X specifies a range of −5.0 mm/s to 0.1 mm/s as the allowable range for the average value that is one feature value corresponding to the first target injection velocity indicated by the information D1. When no value is received by both the input field F23 and the input field F24, the information processing apparatus X determines that the allowable range for the average value, which is one feature value corresponding to the first target injection velocity indicated by the information D1, is not specified. In this case, the information processing apparatus X does not use the allowable range to determine whether an abnormality has occurred in the value of the detection quantity corresponding to the first target injection velocity. In addition, a value may be input to each of the input field F23 and the input field F24 by selecting the value from a pull-down menu, or may be directly input using an input apparatus such as a keyboard.

The information D2 is information indicating the second target injection velocity that is one target value received via the target value reception image P1.

The input field F31 and the input field F32 are input fields for receiving the allowable range for the maximum value that is one feature value corresponding to the second target injection velocity indicated by the information D2. Specifically, the input field F31 is an input field for receiving a lower limit value of the allowable range. In the example shown in FIG. 3, the lower limit value is represented as a value indicating a deviation in a negative direction on a number line from the second target injection velocity. In this example, “5.0” is received by the input field F31 as an example of the lower limit value. This means that the lower limit value is a value smaller than the second target injection velocity by 5.0 mm/s. When the lower limit value is received by the input field F31, the information processing apparatus X specifies the lower limit value received by the input field F31 as the lower limit value of the allowable range. Meanwhile, the input field F32 is an input field for receiving an upper limit value of the allowable range. In this example, the upper limit value is represented as a value indicating a deviation in a positive direction on the number line from the second target injection velocity. In this example, “1.0” is received by the input field F32 as an example of the upper limit value. This means that the upper limit value is a value larger than the second target injection velocity by 1.0 mm/s. When the upper limit value is received by the input field F32, the information processing apparatus X specifies the upper limit value received by the input field F32 as the upper limit value of the allowable range. Upon specifying the lower limit value and the upper limit value, the information processing apparatus X specifies a range from the specified lower limit value to the specified upper limit value as the allowable range. In this example, the information processing apparatus X specifies a range of −5.0 mm/s to 1.0 mm/s as the allowable range for the maximum value that is one feature value corresponding to the second target injection velocity indicated by the information D2. When no value is received by both the input field F31 and the input field F32, the information processing apparatus X determines that the allowable range for the maximum value, which is one feature value corresponding to the second target injection velocity indicated by the information D2, is not specified. In this case, the information processing apparatus X does not use the allowable range to determine whether an abnormality has occurred in a value of a detection quantity corresponding to the second target injection velocity. In addition, a value may be input to each of the input field F31 and the input field F32 by selecting the value from a pull-down menu, or may be directly input using an input apparatus such as a keyboard.

The input field F33 and the input field F34 are input fields for receiving the allowable range for the average value that is one feature value corresponding to the second target injection velocity indicated by the information D2. Specifically, the input field F33 is an input field for receiving a lower limit value of the allowable range. In the example shown in FIG. 3, the lower limit value is represented as a value indicating a deviation in a negative direction on a number line from the second target injection velocity. In this example, “5.0” is received by the input field F33 as an example of the lower limit value. This means that the lower limit value is a value smaller than the second target injection velocity by 5.0 mm/s. When the lower limit value is received by the input field F33, the information processing apparatus X specifies the lower limit value received by the input field F33 as the lower limit value of the allowable range. Meanwhile, the input field F34 is an input field for receiving an upper limit value of the allowable range. In this example, the upper limit value is represented as a value indicating a deviation in a positive direction on the number line from the second target injection velocity. In this example, “0.1” is received by the input field F34 as an example of the upper limit value. This means that the upper limit value is a value larger than the second target injection velocity by 0.1 mm/s. When the upper limit value is received by the input field F34, the information processing apparatus X specifies the upper limit value received by the input field F34 as the upper limit value of the allowable range. Upon specifying the lower limit value and the upper limit value, the information processing apparatus X specifies a range from the specified lower limit value to the specified upper limit value as the allowable range. In this example, the information processing apparatus X specifies a range of −5.0 mm/s to 0.1 mm/s as the allowable range for the average value that is one feature value corresponding to the second target injection velocity indicated by the information D2. When no value is received by both the input field F33 and the input field F34, the information processing apparatus X determines that the allowable range for the average value, which is one feature value corresponding to the second target injection velocity indicated by the information D2, is not specified. In this case, the information processing apparatus X does not use the allowable range to determine whether an abnormality has occurred in the value of the detection quantity corresponding to the second target injection velocity. In addition, a value may be input to each of the input field F33 and the input field F34 by selecting the value from a pull-down menu, or may be directly input using an input apparatus such as a keyboard.

The information D3 is information indicating the target mold temperature that is one target value received via the target value reception image P1.

The input field F41 and the input field F42 are input fields for receiving the allowable range for the maximum value that is one feature value corresponding to the target mold temperature indicated by the information D3. Specifically, the input field F41 is an input field for receiving a lower limit value of the allowable range. In the example shown in FIG. 3, the lower limit value is represented as a value indicating a deviation in a negative direction on a number line from the target mold temperature. In this example, “1.0” is received by the input field F41 as an example of the lower limit value. This means that the lower limit value is a value lower than the target mold temperature by 1.0° C. When the lower limit value is received by the input field F41, the information processing apparatus X specifies the lower limit value received by the input field F41 as the lower limit value of the allowable range. Meanwhile, the input field F42 is an input field for receiving an upper limit value of the allowable range. In this example, the upper limit value is represented as a value indicating a deviation in a positive direction on the number line from the target mold temperature. In this example, “1.0” is received by the input field F42 as an example of the upper limit value. This means that the upper limit value is a value higher than the target mold temperature by 1.0° C. When the upper limit value is received by the input field F42, the information processing apparatus X specifies the upper limit value received by the input field F42 as the upper limit value of the allowable range. Upon specifying the lower limit value and the upper limit value, the information processing apparatus X specifies a range from the specified lower limit value to the specified upper limit value as the allowable range. In this example, the information processing apparatus X specifies a range of −1.0° C. to 1.0° C. as the allowable range for the maximum value that is one feature value corresponding to the target mold temperature indicated by the information D3. When no value is received by both the input field F41 and the input field F42, the information processing apparatus X determines that the allowable range for the maximum value, which is one feature value corresponding to the target mold temperature indicated by the information D3, is not specified. In this case, the information processing apparatus X does not use the allowable range to determine whether an abnormality has occurred in a value of a detection quantity corresponding to the target mold temperature. In addition, a value may be input to each of the input field F41 and the input field F42 by selecting the value from a pull-down menu, or may be directly input using an input apparatus such as a keyboard.

The input field F43 and the input field F44 are input fields for receiving the allowable range for the average value that is one feature value corresponding to the target mold temperature indicated by the information D3. Specifically, the input field F43 is an input field for receiving a lower limit value of the allowable range. In the example shown in FIG. 3, the lower limit value is represented as a value indicating a deviation in a negative direction on a number line from the target mold temperature. In this example, “1.0” is received by the input field F43 as an example of the lower limit value. This means that the lower limit value is a value lower than the target mold temperature by 1.0° C. When the lower limit value is received by the input field F43, the information processing apparatus X specifies the lower limit value received by the input field F43 as the lower limit value of the allowable range. Meanwhile, the input field F44 is an input field for receiving an upper limit value of the allowable range. In this example, the upper limit value is represented as a value indicating a deviation in a positive direction on the number line from the target mold temperature. In this example, “1.0” is received by the input field F44 as an example of the upper limit value. This means that the upper limit value is a value higher than the target mold temperature by 1.0° C. When the upper limit value is received by the input field F44, the information processing apparatus X specifies the upper limit value received by the input field F44 as the upper limit value of the allowable range. Upon specifying the lower limit value and the upper limit value, the information processing apparatus X specifies a range from the specified lower limit value to the specified upper limit value as the allowable range. In this example, the information processing apparatus X specifies a range of −1.0° C. to 1.0° C. as the allowable range for the average value that is one feature value corresponding to the target mold temperature indicated by the information D3. When no value is received by both the input field F43 and the input field F44, the information processing apparatus X determines that the allowable range for the average value, which is one feature value corresponding to the target mold temperature indicated by the information D3, is not specified. In this case, the information processing apparatus X does not use the allowable range to determine whether an abnormality has occurred in the value of the detection quantity corresponding to the target mold temperature. In addition, a value may be input to each of the input field F43 and the input field F44 by selecting the value from a pull-down menu, or may be directly input using an input apparatus such as a keyboard.

The information processing apparatus X can receive, via the allowable range reception image P2 as described above, the allowable range for each feature value corresponding to the target value for each of all the target values received via the target value reception image P1. Accordingly, the information processing apparatus X can generate the abnormality determination condition information associated with each of all the target values received via the target value reception image P1. The abnormality determination condition information may be allowable range information indicating the allowable range for each feature value. The information processing apparatus X outputs the generated abnormality determination condition information to the first target injection molding apparatus. Accordingly, the information processing apparatus X can set the abnormality determination condition indicated by each piece of generated abnormality determination condition information in the first target injection molding apparatus.

When 0.0 is received as a lower limit value of a certain allowable range in the allowable range reception image P2, the information processing apparatus X specifies a range where the lower limit value does not exist as the allowable range. When 0.0 is received as an upper limit value of the certain allowable range in the allowable range reception image P2, the information processing apparatus X specifies a range where the upper limit value does not exist as the allowable range.

In response to a received abnormality determination result image display operation, the information processing apparatus X displays, based on target cycle data specified by the abnormality determination result image display operation in the stored cycle data and target injection molding condition data associated with the target cycle data in the stored injection molding condition data, abnormality determination result information indicating whether an abnormality has occurred in a value of a detection quantity specified by the abnormality determination result image display operation in a cycle in the target cycle data. Hereinafter, for convenience of description, the cycle will be referred to as a target cycle, the detection quantity will be referred to as a target detection quantity, and an injection molding apparatus from which the target cycle data is acquired will be referred to as a second target injection molding apparatus. For example, the information processing apparatus X generates a graph of a detection quantity waveform indicating a change over time in a value of the target detection quantity based on time-series information indicating a time series of the target detection quantity in the target cycle data. After generating the graph, based on target value information indicating one or more target values corresponding to the target detection quantity in target value information in the target injection molding condition data, the information processing apparatus X superimposes, on the graph, a target value waveform indicating a change over time in the target value corresponding to the target detection quantity in control of the target detection quantity by the second target injection molding apparatus. After superimposing the target value waveform on the graph, the information processing apparatus X generates an abnormality determination result image P3 including the graph where the target value waveform is superimposed as the abnormality determination result information, and displays the generated abnormality determination result image P3.

FIG. 4 shows an example of the abnormality determination result image P3. A horizontal axis of the graph shown in FIG. 4 indicates an elapsed time in the target cycle. The horizontal axis of the graph indicates the elapsed time by the screw position. The horizontal axis of the graph may indicate the elapsed time by other information corresponding one-to-one to the elapsed time. A vertical axis of the graph represents a value of the injection velocity that is an example of the target detection quantity. That is, in the example shown in FIG. 4, the detection quantity specified by the abnormality determination result image display operation is the injection velocity. A waveform L1 plotted on the graph shows an example of the target value waveform. A waveform L2 plotted on the graph shows an example of the detection quantity waveform.

In the example shown in FIG. 4, the waveform L1 indicates that the second target injection molding apparatus uses the above-described first target injection velocity as the target value for the injection velocity, which is an example of the target detection quantity, in a period PD1 in which the screw position is from 40 mm to 25 mm. In this example, the waveform L1 indicates that the second target injection molding apparatus uses the above-described second target injection velocity as the target value for the injection velocity, which is an example of the target detection quantity, in a period PD2 in which the screw position is from 25 mm to 20 mm. In this example, the graph shown in FIG. 4 indicates that a maximum value of the waveform L2 in the period PD2 does not satisfy the abnormality determination condition indicated by the abnormality determination condition information associated with the maximum value. In this case, the information processing apparatus X determines that the maximum value of the target detection quantity does not satisfy the abnormality determination condition indicated by the abnormality determination condition information associated with the second target injection velocity, and specifies the period PD2 as the abnormality occurrence period in which an abnormality has occurred in the target cycle. Then, the information processing apparatus X displays the abnormality occurrence period information indicating at least a part of the period PD2 specified as the abnormality occurrence period. Here, in the example shown in FIG. 4, the information processing apparatus X causes a display mode of the period PD2 in the graph to be different from display modes of other periods, thereby displaying, on the graph, the display mode of the period PD2 in the graph as one piece of the abnormality occurrence period information. Accordingly, the information processing apparatus X can easily detect that an abnormality has occurred in the second target injection molding apparatus without preparing information other than the information acquired from the second target injection molding apparatus. Further, by displaying the abnormality occurrence period information, the information processing apparatus X allows a user to easily specify the target value used by the second target injection molding apparatus in the period in which an abnormality has occurred in the target cycle. The information processing apparatus X may cause a part of the display mode of the period PD2 to be different from the display modes of the other periods, thereby displaying the part of the display mode on the graph as one piece of the abnormality occurrence period information. In this case, the part is, for example, a target period in which the maximum value does not satisfy the abnormality determination condition in the period PD2, but is not limited thereto. In this case, the information processing apparatus X may set the target period in the period PD2 and a non-target period other than the target period in the period PD2 to different display modes, thereby displaying the display mode of the target period as one piece of the abnormality occurrence period information and displaying the display mode of the non-target period as second abnormality occurrence period information. In the embodiment, the display mode is color, shape, brightness, hatching, or the like, but is not limited thereto. Hatching of the period PD2 shown in FIG. 4 is an example of such a display mode.

In the example shown in FIG. 4, the information processing apparatus X displays, as one piece of the abnormality occurrence period information, a mark I1 indicating the period PD2 as the abnormality occurrence period on the graph shown in FIG. 4. Accordingly, the information processing apparatus X allows the user to visually specify the abnormality occurrence period more reliably. The mark I1 is a mark indicating the period PD2 by being displayed immediately above the period PD2. A configuration of the mark I1 may be any configuration. In this example, the mark I1 is a mark including an icon indicating that an abnormality has occurred and a character string “INJECTION VELOCITY ABNORMAL”. The mark I1 may indicate the period PD2 by, for example, a callout, a leader line, or an arrow indicating a width of the period PD2. The information processing apparatus X may not display the mark I1. In this case, the information processing apparatus X still displays other information indicating the period PD2 as the abnormality occurrence period, such as the display mode of the period PD2.

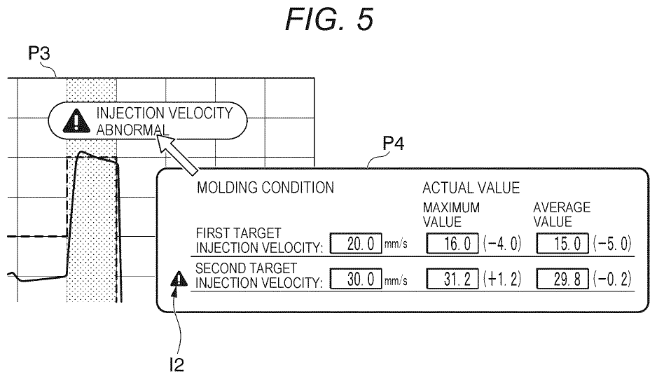

When a predetermined operation is performed on the mark I1 in the abnormality determination result image P3, the information processing apparatus X displays a first detailed information image P4 where a target value and a feature value corresponding to the target value are displayed side by side for each of one or more target values corresponding to the target detection quantity. Here, FIG. 5 shows an example of the first detailed information image P4. In the example shown in FIG. 5, the operation is mouseover onto the mark I1. In this example, the first detailed information image P4 is superimposed on the graph shown in FIG. 4 by the operation. In this example, in the first detailed information image P4, the first target injection velocity, the maximum value of the injection velocity, which is an example of the target detection quantity in the period in which the second target injection molding apparatus uses the first target injection velocity, and the average value of the injection velocity in the period are displayed side by side in one row. In this example, a difference between the maximum value and the first target injection velocity is displayed in association with the maximum value. Accordingly, the information processing apparatus X allows the user to easily recognize a magnitude of the deviation of the value of the injection velocity from the first target injection velocity. This leads to reduction in a time required for the user to manage the cycle, which is useful. In this example, the difference between the average value and the first target injection velocity is displayed in association with the average value. This also enables the information processing apparatus X to allow the user to easily recognize the magnitude of the deviation of the value of the injection velocity from the average first target injection velocity. This also leads to reduction in the time required for the user to manage the cycle, which is useful. In this example, in the first detailed information image P4, the second target injection velocity, the maximum value of the injection velocity in the period in which the second target injection molding apparatus uses the second target injection velocity, and the average value of the injection velocity in the period are displayed side by side. In this example, a difference between the maximum value and the second target injection velocity is displayed in association with the maximum value. Accordingly, the information processing apparatus X allows the user to easily recognize a magnitude of the deviation of the value of the injection velocity from the second target injection velocity. This leads to reduction in the time required for the user to manage the cycle, which is useful. In this example, the difference between the average value and the second target injection velocity is displayed in association with the average value. This also enables the information processing apparatus X to allow the user to easily recognize the magnitude of the deviation of the value of the injection velocity from the average second target injection velocity. This also leads to reduction in the time required for the user to manage the cycle, which is useful. Further, in this example, the information processing apparatus X displays, in association with the second target injection velocity, an icon 12 indicating that an abnormality occurs in the value of the injection velocity. A configuration of the icon 12 may be any configuration. By displaying the icon 12 in association with the second target injection velocity in the first detailed information image P4, the information processing apparatus X allows the user to easily specify the target value used for control of the injection velocity by the second target injection molding apparatus in a period in which an abnormality has occurred in the value of the injection velocity among one or more target values corresponding to the injection velocity.

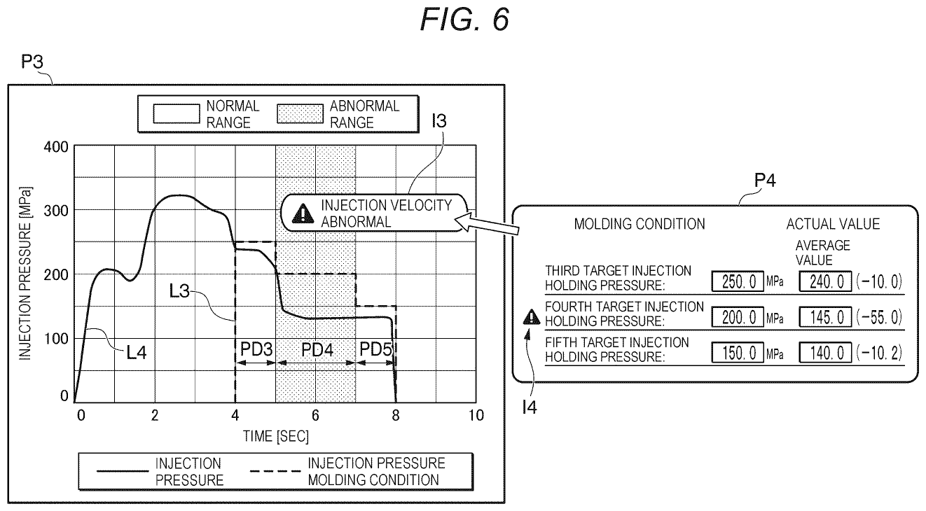

Meanwhile, FIG. 6 shows another example of the abnormality determination result image P3. A horizontal axis of the graph shown in FIG. 6 indicates the elapsed time in the target cycle. A vertical axis of the graph indicates a value of the injection holding pressure that is another example of the target detection quantity. A waveform L3 plotted on the graph shows an example of the target value waveform indicating a change over time in the target value corresponding to the injection holding pressure in control of the injection holding pressure by the second target injection molding apparatus. A waveform L4 plotted on the graph shows an example of the detection quantity waveform indicating a change over time in the injection holding pressure.

In the example shown in FIG. 6, the waveform L3 indicates that the second target injection molding apparatus uses 250 MPa as the target value for the injection holding pressure, which is an example of the target detection quantity, in a period PD3 in which the elapsed time is from 4 sec to 5 sec. Hereinafter, for convenience of description, 250 MPa will be referred to as a third target injection holding pressure. In this example, the waveform L3 indicates that the second target injection molding apparatus uses 200 MPa as the target value for the injection holding pressure, which is an example of the target detection quantity, in a period PD4 in which the elapsed time is from 5 sec to 7 sec. Hereinafter, for convenience of description, 200 MPa will be referred to as a fourth target injection holding pressure. In this example, the waveform L3 indicates that the second target injection molding apparatus uses 150 MPa as the target value for the injection holding pressure, which is an example of the target detection quantity, in a period PD5 in which the elapsed time is from 7 sec to 8 sec. Hereinafter, for convenience of description, 150 MPa will be referred to as a fifth target injection holding pressure. In this example, the graph indicates that an average value of the waveform L4 in the period PD4 does not satisfy the abnormality determination condition indicated by the abnormality determination condition information associated with the average value. In this case, the information processing apparatus X determines that the average value of the injection holding pressure does not satisfy the abnormality determination condition indicated by the abnormality determination condition information associated with the fourth target injection holding pressure, and specifies the period PD4 as the abnormality occurrence period in which an abnormality has occurred in the target cycle. Then, the information processing apparatus X displays the abnormality occurrence period information indicating at least a part of the period PD4 specified as the abnormality occurrence period. Here, in the example shown in FIG. 6, the information processing apparatus X causes a display mode of the period PD4 in the graph to be different from display modes of other periods, thereby displaying, on the graph, the display mode of the period PD4 in the graph as one piece of the abnormality occurrence period information. Accordingly, the information processing apparatus X can easily detect that an abnormality has occurred in the second target injection molding apparatus without preparing information other than the information acquired from the second target injection molding apparatus. Further, by displaying the abnormality occurrence period information, the information processing apparatus X allows the user to easily specify the target value used by the second target injection molding apparatus in the period in which an abnormality has occurred in the target cycle. Since the display mode of the period PD4 is the same as the display mode of the period PD2, a detailed description thereof will be omitted here.

In the example shown in FIG. 6, the information processing apparatus X displays, as one piece of the abnormality occurrence period information, a mark I3 indicating the period PD4 as the abnormality occurrence period. Accordingly, the information processing apparatus X allows the user to visually specify the abnormality occurrence period more reliably. The mark I3 is a mark indicating the period PD4 by being displayed immediately above the period PD4. Since a configuration of the mark I3 is the same as the configuration of the mark I1, a detailed description thereof will be omitted here.

In the abnormality determination result image P3 shown in FIG. 6, a first detailed information image P4 different from the first detailed information image P4 shown in FIG. 5 is displayed. This is because the information processing apparatus X displays the first detailed information image P4 by an operation onto the mark I3. In the example shown in FIG. 6, the third target injection holding pressure and the average value of the injection holding pressure in a period in which the second target injection molding apparatus uses the third target injection holding pressure are displayed side by side in one row in the first detailed information image P4. In this example, a difference between the average value and the third target injection holding pressure is displayed in association with the average value. Accordingly, the information processing apparatus X allows the user to easily recognize a magnitude of an average deviation of the value of the injection holding pressure from the third target injection holding pressure. This leads to reduction in the time required for the user to manage the cycle, which is useful. In this example, the fourth target injection holding pressure and the average value of the injection holding pressure in a period in which the second target injection molding apparatus uses the fourth target injection holding pressure are displayed side by side in a row below the one row in the first detailed information image P4. In this example, a difference between the average value and the fourth target injection holding pressure is displayed in association with the average value. Accordingly, the information processing apparatus X allows the user to easily recognize a magnitude of an average deviation of the value of the injection holding pressure from the fourth target injection holding pressure. This also leads to reduction in the time required for the user to manage the cycle, which is useful. In this example, the fifth target injection holding pressure and the average value of the injection holding pressure in a period in which the second target injection molding apparatus uses the fifth target injection holding pressure are displayed side by side in a row further below the lower row in the first detailed information image P4. In this example, a difference between the average value and the fifth target injection holding pressure is displayed in association with the average value. Accordingly, the information processing apparatus X allows the user to easily recognize a magnitude of an average deviation of the value of the injection holding pressure from the fifth target injection holding pressure. This also leads to reduction in the time required for the user to manage the cycle, which is useful. Further, in this example, the information processing apparatus X displays, in association with the fourth target injection holding pressure, an icon 14 indicating that an abnormality occurs in the value of the injection holding pressure. A configuration of the icon 14 may be the same configuration as the configuration of the icon 12 or may be a configuration different from the configuration of the icon 12. By displaying the icon 14 in association with the fourth target injection holding pressure in the first detailed information image P4, the information processing apparatus X allows the user to easily specify the target value used for control of the injection holding pressure by the second target injection molding apparatus in the period in which an abnormality has occurred in the value of the injection holding pressure among one or more target values corresponding to the injection holding pressure.

When a predetermined second detailed information image display operation is received, the information processing apparatus X displays a second detailed information image P5 based on second target cycle data specified by the second detailed information image display operation in the stored cycle data and second target injection molding condition data associated with the second target cycle data in the stored injection molding condition data. The second detailed information image P5 is an image in which a target value and a value related to a detection quantity corresponding to the target value are displayed for each of one or more target values corresponding to the detection quantity specified by the second detailed information image display operation in a cycle in the second target cycle data. In the second detailed information image P5, the value related to the detection quantity corresponding to a certain target value is a part or all of one or more feature values for the detection quantity, a statistical value of a part or all of the one or more feature values in past N cycles executed most recently among cycles before the cycle in the second target cycle data, or the like, but is not limited thereto. N may be any integer equal to or greater than 2. The statistical value is, for example, a maximum value, an average value, or the like, but is not limited thereto. Hereinafter, for convenience of description, the cycle will be referred to as a second target cycle, the detection quantity will be referred to as a second target detection quantity, and an injection molding apparatus from which the second target cycle data is acquired will be referred to as a third target injection molding apparatus. Hereinafter, a case in which N is 10 will be described as an example.

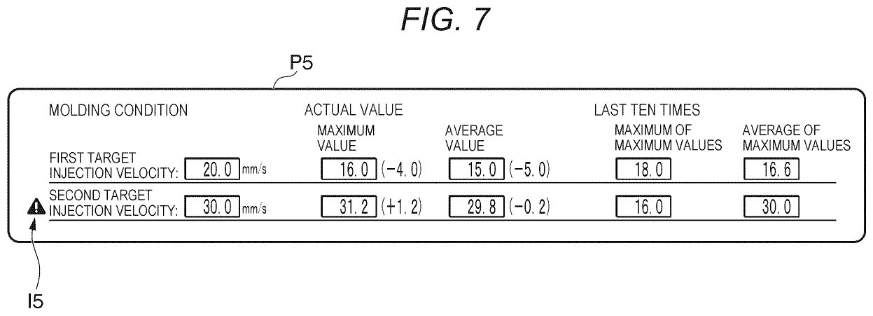

FIG. 7 shows an example of the second detailed information image P5. In the example shown in FIG. 7, in the second detailed information image P5, the first target injection velocity, which is an example of the target value corresponding to the injection velocity that is an example of the second target detection quantity, the maximum value of the injection velocity during a period in which the third target injection molding apparatus uses the first target injection velocity in the second target cycle, the average value of the injection velocity, the maximum value of the injection velocity during the period in past ten cycles executed most recently among cycles before the second target cycle, and the average value of the injection velocity during the period in the past ten cycles are displayed side by side in one row. In this example, a difference between the first target injection velocity and the maximum value of the injection velocity in the period in the second target cycle is displayed in association with the maximum value. Accordingly, the information processing apparatus X allows the user to easily recognize a magnitude of the deviation of the value of the injection velocity from the first target injection velocity, and allows the user to easily recognize a variation in the injection velocity in the period in the past ten cycles. In this example, in the second detailed information image P5, the second target injection velocity, which is another example of the target value corresponding to the injection velocity that is an example of the second target detection quantity, the maximum value of the injection velocity during a period in which the third target injection molding apparatus uses the second target injection velocity in the second target cycle, the average value of the injection velocity, the maximum value of the injection velocity during the period in the past ten cycles executed most recently among cycles before the second target cycle, and the average value of the injection velocity during the period in the past ten cycles are displayed side by side in a row immediately below the row including the first target injection velocity. In this example, a difference between the second target injection velocity and the maximum value of the injection velocity in the period in the second target cycle is displayed in association with the maximum value. Accordingly, the information processing apparatus X allows the user to easily recognize a magnitude of the deviation of the value of the injection velocity from the second target injection velocity, and allows the user to easily recognize the variation in the injection velocity in the period in the past ten cycles. These lead to reduction in the time required for the user to manage the cycle, which is useful.

Further, in the example shown in FIG. 7, the information processing apparatus X displays an icon 15 indicating that an abnormality occurs in the value of the injection velocity in association with the second target injection velocity. A configuration of the icon 15 may be any configuration. By displaying the icon 15 in association with the second target injection velocity in the second detailed information image P5, the information processing apparatus X allows the user to easily specify the target value used for control of the injection velocity by the third target injection molding apparatus in a period in which an abnormality has occurred in the value of the injection velocity among one or more target values corresponding to the injection velocity.

### Hardware Configuration of Information Processing Apparatus X

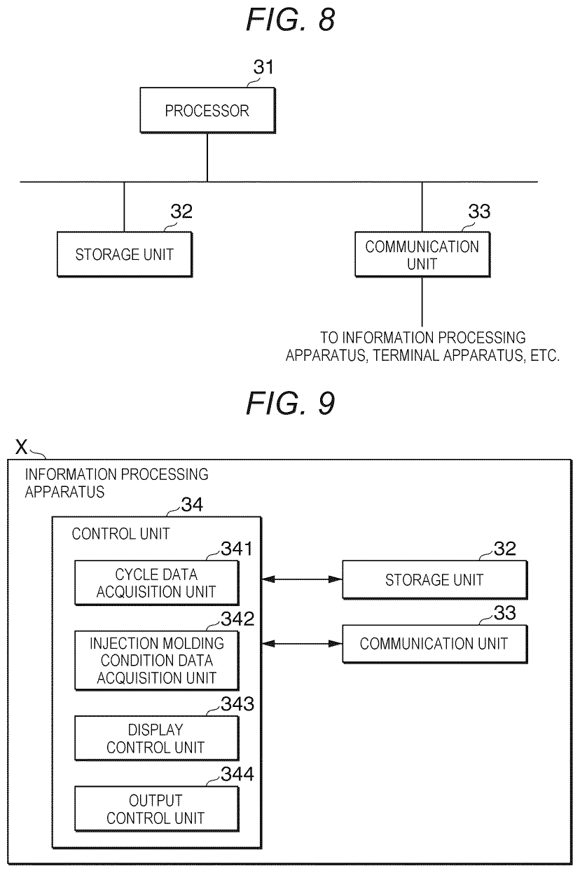

Here, the information processing apparatus 20 and the server 30 may have the same hardware configuration or may have different hardware configurations. Hereinafter, as an example, a case will be described in which the information processing apparatus 20 and the server 30 have the same hardware configuration. In other words, in this example, the information processing apparatus X has a hardware configuration as shown in FIG. 8. FIG. 8 shows an example of the hardware configuration of the information processing apparatus X.

The information processing apparatus X includes, for example, a processor 31, a storage unit 32, and a communication unit 33. These component elements are communicably connected to one another via a bus. The information processing apparatus X communicates with another apparatus via the communication unit 33. For example, when the information processing apparatus X is the information processing apparatus 20, the other apparatus is the injection molding apparatus, the server 30, or the terminal apparatus 40. For example, when the information processing apparatus X is the server 30, the other apparatus is the information processing apparatus 20 or the terminal apparatus 40.

The processor 31 is, for example, a central processing unit (CPU). Instead of the CPU, the processor 31 may be another processor such as a field programmable gate array (FPGA). The processor 31 executes various programs stored in the storage unit 32.

The storage unit 32 is, for example, a storage device including a hard disk drive (HDD), a solid-state drive (SSD), an electrically erasable programmable read-only memory (EEPROM), a read-only memory (ROM), or a random access memory (RAM). Instead of being built in the information processing apparatus X, the storage unit 32 may be an external storage device coupled to a digital input and output port such as a universal serial bus (USB). The storage unit 32 stores various information, various images, and various programs to be processed by the information processing apparatus X. That is, the various information stored by the information processing apparatus X is stored in the storage unit 32.

The communication unit 33 is a communication device including, for example, a digital input and output port such as a USB, an Ethernet (registered trademark) port, and an antenna for wireless communication.

### Functional Configuration of Information Processing Apparatus X

Here, the information processing apparatus 20 and the server 30 may have the same functional configuration or may have different functional configurations. Hereinafter, as an example, a case will be described in which the information processing apparatus 20 and the server 30 have the same functional configuration. In other words, in this example, the information processing apparatus X has a functional configuration as shown in FIG. 9. FIG. 9 shows an example of the functional configuration of the information processing apparatus X.

The information processing apparatus X includes the storage unit 32, the communication unit 33, and a control unit 34.

The control unit 34 controls the entire information processing apparatus X. The control unit 34 includes at least a cycle data acquisition unit 341, an injection molding condition data acquisition unit 342, a display control unit 343, and an output control unit 344. These functional units provided in the control unit 34 are implemented by, for example, the processor 31 executing the various programs stored in the storage unit 32. A part or all of the functional units may be hardware functional units such as a large scale integration (LSI) or an application specific integrated circuit (ASIC).

The cycle data acquisition unit 341 acquires the cycle data for each cycle of each injection molding apparatus from an apparatus communicably connected to the information processing apparatus X. The apparatus is, for example, the injection molding apparatus or the information processing apparatus 20.

The injection molding condition data acquisition unit 342 acquires the injection molding condition data from the apparatus communicably connected to the information processing apparatus X each time the injection molding condition is set in each injection molding apparatus. The apparatus is, for example, the injection molding apparatus or the information processing apparatus 20.

The display control unit 343 generates various images in response to a received operation. For example, the display control unit 343 generates the target value reception image P1 described above. The display control unit 343 transmits the generated image to the terminal apparatus 40 and causes the terminal apparatus 40 to display the target value reception image P1.

The output control unit 344 outputs various types of data to another apparatus in response to a received operation.

### Processing Performed by Information Processing Apparatus X in Response to Received Operation

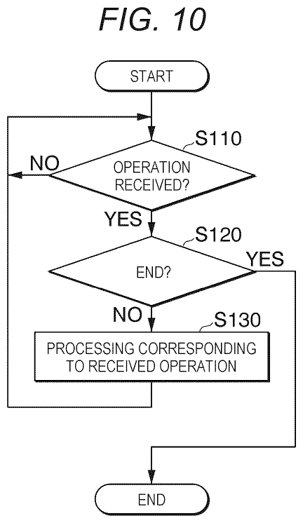

Processing performed by the information processing apparatus X in response to each operation described above will be described with reference to FIG. 10. FIG. 10 shows an example of a flow of the processing performed by the information processing apparatus X in response to the received operation. Hereinafter, as an example, a case will be described in which the information processing apparatus X is in a state in which various operations from the user can be received via the terminal apparatus 40 at a timing before processing in step S110 shown in FIG. 10 is performed. Hereinafter, as an example, a case will be described in which a plurality of pieces of cycle data and a plurality of pieces of injection molding condition data are already stored in the information processing apparatus X at the timing.

The control unit 34 waits until an operation is received via the terminal apparatus 40 (step S110). In FIG. 10, the processing in step S110 is indicated by “OPERATION RECEIVED?”.

When it is determined that the operation has been received via the terminal apparatus 40 (step S110—YES), the control unit 34 determines whether the received operation is operation for ending the processing of the flowchart shown in FIG. 10 (step S120). The control unit 34 may perform the determination processing in step S120 by a known method or by a method to be developed. In FIG. 10, the processing in step S120 is indicated by “END?”.

When it is determined that the operation received in step S110 is the operation for ending the processing of the flowchart shown in FIG. 10 (step S120—YES), for example, the control unit 34 ends the processing of the flowchart shown in FIG. 10.

On the other hand, when it is determined that the operation received in step S110 is not the operation for ending the processing of the flowchart shown in FIG. 10 (step S120—NO), the control unit 34 performs processing corresponding to the received operation (step S130). The processing includes various types of processing described as the processing performed by the information processing apparatus X in the embodiment. Here, since the processing performed by the control unit 34 in step S130 is already described with reference to FIGS. 2 to 7, a detailed description thereof will be omitted.

After the processing in step S130 is performed, the control unit 34 transitions to step S110 and waits again until an operation is received via the terminal apparatus 40.

By the processing as described above, in response to the received abnormality determination result image display operation, the information processing apparatus X specifies, based on the target cycle data specified by the abnormality determination result image display operation in the stored cycle data and the target injection molding condition data associated with the target cycle data in the stored injection molding condition data, the abnormality occurrence period in which an abnormality has occurred in the target cycle, and displays the abnormality occurrence period information indicating at least a part of the specified abnormality occurrence period. Accordingly, the information processing apparatus X can easily detect that an abnormality has occurred in the injection molding apparatus without preparing information other than the information acquired from the injection molding apparatus.

The molding management system 1 described above may include the terminal apparatus 40. The molding management system 1 described above may include an injection molding apparatus such as the injection molding apparatus 11.

The contents described above may be combined in any manner.

### Appendices

(1)

A molding management system that manages production of a product in a production process including an injection molding process of the product by an injection molding apparatus, the molding management system including: an information processing apparatus communicably connected to a terminal apparatus, in which the information processing apparatus acquires, from the injection molding apparatus for each cycle in which injection molding is performed, cycle data including first quantity information indicating a value of a first quantity controlled by the injection molding apparatus during execution of the cycle, acquires, from the injection molding apparatus each time an injection molding condition is set in the injection molding apparatus, injection molding condition data including first target value information indicating a first target value that is a target value in control of the first quantity by the injection molding apparatus as one piece of injection molding condition information indicating the injection molding condition set in the injection molding apparatus in the cycle, and causes a display unit to display, based on first cycle data in the cycle data acquired from the injection molding apparatus and first injection molding condition data associated with the first cycle data in the acquired injection molding condition data in response to a received first operation, abnormality occurrence period information indicating at least a part of an abnormality occurrence period in which an abnormality occurs in a first cycle that is the cycle in the first cycle data.

(2)

The molding management system according to [1], in which the information processing apparatus causes the display unit to display the abnormality occurrence period information together with a graph of a waveform indicating a change over time in the first quantity in the first cycle in response to the first operation.

(3)

The molding management system according to [1] or [2], in which, when a value indicated by the first quantity information in the first cycle data does not satisfy an abnormality determination condition corresponding to the first target value indicated by the first target value information in the first injection molding condition data, the information processing apparatus specifies, as the abnormality occurrence period, a period in which the first target value is used for controlling the first quantity by the injection molding apparatus in the first cycle.

(4)

The molding management system according to [3], in which the abnormality determination condition is a monitoring condition received for monitoring a change over time in the first quantity to prevent deterioration in quality of the product or occurrence of an abnormality in the injection molding apparatus.

(5)

The molding management system according to [3] or [4], in which the abnormality determination condition is that the value of the first quantity does not exceed the first target value.

(6)

The molding management system according to [5], in which the first quantity information includes time-series information indicating a time series of the value of the first quantity.

(7)

The molding management system according to [3], in which the first quantity information includes, as one piece of information indicating the value of the first quantity, first feature value information indicating a first feature value for the first quantity, the injection molding condition data includes, as one piece of the injection molding condition information, first allowable range information indicating an allowable range for the first feature value, the allowable range for the first feature value is a range where the first feature value deviates when the value of the first quantity deviates from a range where deviation of the value of the first quantity from the first target value is allowed, and is a range where the first feature value does not deviate when the value of the first quantity does not deviate from the range where the deviation of the value of the first quantity from the first target value is allowed, and the abnormality determination condition is that the first feature value does not deviate from the allowable range for the first feature value.

(8)

The molding management system according to [7], in which the first feature value information is first time-series information indicating a time series of the value of the first quantity, and the information processing apparatus calculates the first feature value based on the first time-series information.

(9)

The molding management system according to [7] or [8], in which the first feature value is any one of a minimum value, a maximum value, an average value, a variance, and a standard deviation of the first quantity, a start value of a detection period in which the first quantity is detected, and an end value of the detection period.

(10)

The molding management system according to [7] or [9], in which the first feature value information is information indicating the first feature value itself.

(11)

The molding management system according to any one of [7] to [10], in which the information processing apparatus causes the display unit to display the abnormality occurrence period information together with a graph of a waveform indicating a change over time in the first quantity in the first cycle in response to the first operation.

(12)

The molding management system according to [11], in which a horizontal axis of the graph indicates information corresponding one-to-one to an elapsed time in the first cycle.

(13)

The molding management system according to [11] or [12], in which the information processing apparatus causes a display mode of at least a part of the abnormality occurrence period in the graph to be different from a display mode of another period, thereby displaying the display mode of the at least a part on the graph as the abnormality occurrence period information.

(14)

The molding management system according to any one of [11] to [13], in which the information processing apparatus causes a mark indicating at least a part of the abnormality occurrence period in the graph to be displayed on the graph as the abnormality occurrence period information.

(15)

The molding management system according to [14], in which the information processing apparatus causes the display unit to display a first image in which the first target value and the first feature value are displayed side by side, when a predetermined second operation is performed on the mark.

(16)

The molding management system according to [15], in which the information processing apparatus displays a difference between the first target value and the first feature value in the first image in association with the first feature value.

(17)

The molding management system according to any one of [7] to [16], in which, when a predetermined third operation is received, the information processing apparatus causes the display unit to display a second image for displaying the first target value indicated by the first target value information in the first injection molding condition data, the first feature value indicated by the first feature value information in the first cycle data, and a statistical value of the first feature value from past N cycles executed most recently among cycles prior to the first cycle, and N is an integer of 2 or more.

(18)

The molding management system according to [17], in which the information processing apparatus displays a difference between the first target value and the first feature value in the second image in association with the first feature value.

(19)

The molding management system according to any one of [7] to [18], in which, when a predetermined fourth operation is received, the information processing apparatus causes the display unit to display a third image for receiving the allowable range for the first feature value.

(20)

The molding management system according to any one of [1] to [19], in which the information processing apparatus causes the display unit to display, as at least a part of the abnormality occurrence period, the abnormality occurrence period information indicating a target period in which an abnormality occurs in the abnormality occurrence period, and causes the display unit to display second abnormality occurrence period information indicating a period other than the target period in the abnormality occurrence period.

(21)

The molding management system according to any one of [1] to [20], further including the terminal apparatus.

(22)

The molding management system according to any one of [1] to [21], further including the injection molding apparatus.

Although the embodiment of the disclosure is described in detail with reference to the drawings, a specific configuration is not limited to the embodiment and may be changed, replaced, deleted, or the like without departing from the gist of the disclosure.

A program for implementing a function of any component in the apparatus described above may be recorded in a computer-readable recording medium, and the program may be read and executed by a computer system. Here, the apparatus is, for example, the injection molding apparatus 11, the information processing apparatus 20, the server 30, or the terminal apparatus 40. The term “computer system” as used herein includes hardware such as an operating system (OS) and peripheral devices. The “computer-readable recording medium” refers to a portable medium such as a flexible disc, a magneto-optical disc, a ROM, or a compact disk (CD) ROM, or a storage apparatus such as a hard disk built in the computer system. Further, the “computer-readable recording medium” includes a medium that stores the program for a certain period of time, such as a volatile memory inside the computer system serving as a server or a client when the program is transmitted via a network such as the Internet or a communication line such as a telephone line.

The program may be transmitted from a computer system in which the program is stored in a storage apparatus or the like to another computer system via a transmission medium or by a transmission wave in the transmission medium. Here, the “transmission medium” for transmitting the program refers to a medium having a function of transmitting information like a network such as the Internet or a communication line such as a telephone line.

The program may be a program for implementing a part of the functions described above. Further, the program may be a so-called difference file or difference program that can implement the functions described above in combination with a program already recorded in the computer system.

What is claimed is:

1. A molding management system that manages production of a product in a production process including an injection molding process of the product by an injection molding apparatus, the molding management system comprising:
an information processing apparatus communicably connected to a terminal apparatus, wherein
the information processing apparatus
acquires, from the injection molding apparatus for each cycle in which injection molding is performed, cycle data including first quantity information indicating a value of a first quantity controlled by the injection molding apparatus during execution of the cycle,
acquires, from the injection molding apparatus each time an injection molding condition is set in the injection molding apparatus, injection molding condition data including first target value information indicating a first target value that is a target value in control of the first quantity by the injection molding apparatus as one piece of injection molding condition information indicating the injection molding condition set in the injection molding apparatus in the cycle, and
causes a display unit to display, based on first cycle data in the cycle data acquired from the injection molding apparatus and first injection molding condition data associated with the first cycle data in the acquired injection molding condition data in response to a received first operation, abnormality occurrence period information indicating at least a part of an abnormality occurrence period in which an abnormality occurs in a first cycle that is the cycle in the first cycle data.

2. The molding management system according to claim 1, wherein
the information processing apparatus causes the display unit to display the abnormality occurrence period information together with a graph of a waveform indicating a change over time in the first quantity in the first cycle in response to the first operation.

3. The molding management system according to claim 1, wherein
when a value indicated by the first quantity information in the first cycle data does not satisfy an abnormality determination condition corresponding to the first target value indicated by the first target value information in the first injection molding condition data, the information processing apparatus specifies, as the abnormality occurrence period, a period in which the first target value is used for controlling the first quantity by the injection molding apparatus in the first cycle.

4. The molding management system according to claim 3, wherein
the abnormality determination condition is a monitoring condition received for monitoring a change over time in the first quantity to prevent deterioration in quality of the product or occurrence of an abnormality in the injection molding apparatus.

5. The molding management system according to claim 3, wherein
the abnormality determination condition is that the value of the first quantity does not exceed the first target value.

6. The molding management system according to claim 5, wherein
the first quantity information includes time-series information indicating a time series of the value of the first quantity.

7. The molding management system according to claim 3, wherein
the first quantity information includes, as one piece of information indicating the value of the first quantity, first feature value information indicating a first feature value for the first quantity,
the injection molding condition data includes, as one piece of the injection molding condition information, first allowable range information indicating an allowable range for the first feature value,
the allowable range for the first feature value is a range where the first feature value deviates when the value of the first quantity deviates from a range where deviation of the value of the first quantity from the first target value is allowed, and is a range where the first feature value does not deviate when the value of the first quantity does not deviate from the range where the deviation of the value of the first quantity from the first target value is allowed, and
the abnormality determination condition is that the first feature value does not deviate from the allowable range for the first feature value.

8. The molding management system according to claim 7, wherein
the first quantity information includes first time-series information indicating a time series of the value of the first quantity, and
the information processing apparatus calculates the first feature value based on the first time-series information.

9. The molding management system according to claim 7, wherein
the first feature value is any one of a minimum value, a maximum value, an average value, a variance, and a standard deviation of the first quantity, a start value of a detection period in which the first quantity is detected, and an end value of the detection period.

10. The molding management system according to claim 7, wherein
the first feature value information is information indicating the first feature value itself.

11. The molding management system according to claim 7, wherein
the information processing apparatus causes the display unit to display the abnormality occurrence period information together with a graph of a waveform indicating a change over time in the first quantity in the first cycle in response to the first operation.

12. The molding management system according to claim 11, wherein
a horizontal axis of the graph indicates information corresponding one-to-one to an elapsed time in the first cycle.

13. The molding management system according to claim 11, wherein
the information processing apparatus causes a display mode of at least a part of the abnormality occurrence period in the graph to be different from a display mode of another period, thereby displaying the display mode of the at least a part on the graph as the abnormality occurrence period information.

14. The molding management system according to claim 11, wherein
the information processing apparatus causes a mark indicating at least a part of the abnormality occurrence period in the graph to be displayed on the graph as the abnormality occurrence period information.

15. The molding management system according to claim 14, wherein
the information processing apparatus causes the display unit to display a first image in which the first target value and the first feature value are displayed side by side, when a predetermined second operation is performed on the mark.

16. The molding management system according to claim 15, wherein
the information processing apparatus displays a difference between the first target value and the first feature value in the first image in association with the first feature value.

17. The molding management system according to claim 7, wherein
when a predetermined third operation is received, the information processing apparatus causes the display unit to display a second image for displaying the first target value indicated by the first target value information in the first injection molding condition data, the first feature value indicated by the first feature value information in the first cycle data, and a statistical value of the first feature value from past N cycles executed most recently among cycles prior to the first cycle, and
N is an integer of 2 or more.

18. The molding management system according to claim 17, wherein
the information processing apparatus displays a difference between the first target value and the first feature value in the second image in association with the first feature value.

19. The molding management system according to claim 7, wherein
when a predetermined fourth operation is received, the information processing apparatus causes the display unit to display a third image for receiving the allowable range for the first feature value.

20. The molding management system according to claim 1, wherein
the information processing apparatus causes the display unit to display, as at least a part of the abnormality occurrence period, the abnormality occurrence period information indicating a target period in which an abnormality occurs in the abnormality occurrence period, and causes the display unit to display second abnormality occurrence period information indicating a period other than the target period in the abnormality occurrence period.

21. The molding management system according to claim 1, further comprising:
the terminal apparatus.

22. The molding management system according to claim 1, further comprising:
the injection molding apparatus.
